(19) United States
(12) Patent Application Publication
(10) Pub. No.: US 2019/0080226 A1
(43) Pub. Date: Mar. 14, 2019

(54) METHOD OF DESIGNING NEURAL NETWORK SYSTEM

(71) Applicant: LITE-ON TECHNOLOGY CORPORATION, Taipei (TW)

(72) Inventors: Chen-Yi Lee, Taipei City (TW); Wan-Ju Yu, Taipei City (TW)

(21) Appl. No.: 15/831,450

(22) Filed: Dec. 5, 2017

(30) Foreign Application Priority Data
Sep. 8, 2017 (CN) 201710803962.4

(51) Int. Cl. G06N 3/04; G06N 3/08

(52) U.S. Cl. CPC G06N 3/0481; G06N 3/08

(57) ABSTRACT

A method of designing a neural network system includes the following steps. Firstly, a neural network system is defined. The neural network system includes an original weight group containing plural neuron connection weights. Then, a training phase is performed to acquire values of the plural neuron connection weights in the original weight group. Then, the plural neuron connection weights into first-portion neuron connection weights and second-portion neuron connection weights according to a threshold value, wherein absolute values of the first-portion neuron connection weights are lower than the threshold value. Then, the values of the first-portion neuron connection weights are modified to zero. Then, a modified weight group is generated. The zero-modified first-portion neuron connection weights and the second-portion neuron connection weights are combined as the modified weight group.

This application claims the benefit of People's Republic of China Application Serial No. 201710803962.4, filed Sep. 8, 2017, the subject matter of which is incorporated herein by reference.

### FIELD OF THE INVENTION

The present invention relates to a neural network system, and more particularly to a method of designing a neural network system.

### BACKGROUND OF THE INVENTION

Recently, a deep learning algorithm has been applied to many systems to provide the intelligent processing capability such as the data classification capability and the object detection capability. For achieving high inference accuracy, the architecture of the deep learning model becomes more and more complicated. As the size of the pre-trained model is increased, the capacity of the external memory is increased to store all of the data of the pre-trained model. However, the time period to read the data of the external memory is increased, the system performance will be limited.

### SUMMARY OF THE INVENTION

An embodiment of the present invention provides a method of designing a neural network system. Firstly, a neural network system is defined. The neural network system includes an original weight group containing plural neuron connection weights. Then, a training phase is performed to acquire values of the plural neuron connection weights in the original weight group. Then, the plural neuron connection weights are grouped into first-portion neuron connection weights and second-portion neuron connection weights according to a threshold value, wherein absolute values of the first-portion neuron connection weights are lower than the threshold value. Then, the values of the first-portion neuron connection weights are modified to zero. Then, a modified weight group is generated. The zero-modified first-portion neuron connection weights and the second-portion neuron connection weights are combined as the modified weight group.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating the architecture of a neural network system for recognizing numbers;

FIG. 2 is a plot illustrating the recognizing accuracy and the count of neuron connection weights for the neural network systems with different sizes;

FIG. 3 schematically illustrates the access latency and the storage capacity of various storage devices;

FIG. 4A schematically illustrates the distribution curves of the neuron connection weights of the neural network system;

FIG. 4B is a plot illustrating the recognizing accuracy and the sparsity for different threshold values Wₜₕ;

FIG. 5 is a flowchart illustrating a method of designing a neural network system according to an embodiment of the present invention;

FIG. 6A schematically illustrates the storage format and the mapping rule of the neuron connection weights for the neural network system of the present invention;

FIG. 6B schematically illustrates a process of creating the modified weight group for the neural network system of the present invention;

FIG. 7A is a schematic functional block diagram illustrating the hardware architecture of a neural network system according to an embodiment of the present invention; and

FIG. 7B is a schematic circuit block diagram illustrating the transcoding circuit used in the hardware architecture of the neural network system as shown in FIG. 7A.

### DETAILED DESCRIPTION OF PREFERRED EMBODIMENTS

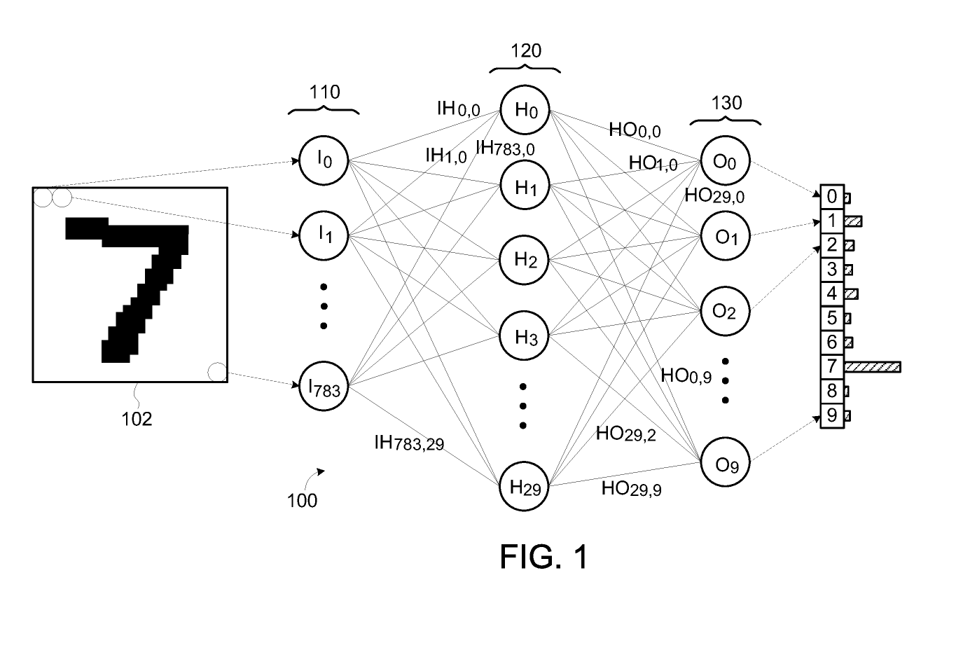

FIG. 1 is a schematic diagram illustrating the architecture of a neural network system for recognizing single digital number. The neural network system 100 is used for recognizing the handwritten numbers on a handwriting board 102. The handwriting board 102 is composed of 784 (=28×28) sensing points.

As shown in FIG. 1, the neural network system 100 comprises an input layer 110, a hidden layer 120 and an output layer 130. Generally, each sensing point on the handwriting board 102 corresponds to an input neuron of the input layer. Consequently, the input layer 110 comprises 784 (=28×28) input neurons I₀˜I₇₈₃. It means that the size of the input layer 110 is 748.

Since the neural network system 100 has to recognize ten digital numbers 0˜9, the output layer 130 comprises ten output neuron O₀˜O₉. It means that the size of the output layer 130 is 10.

The hidden layer 120 of the neural network system 100 comprises 30 neurons H₀˜H₂₉. That is, the size of the hidden layer 120 is 30. Consequently, the size of the neural network system 100 is indicated as 784-30-10.

Each connection line between the input layer 110 and the hidden layer 120 denotes a neuron connection weight. Similarly, each connection line between the hidden layer 120 and the output layer 130 also denotes a neuron connection weight. Please refer to FIG. 1. The neuron connection weights between the 784 input neurons I₀˜I₇₈₃ of the input layer 110 and the neuron H₀ of the hidden layer 120 are indicated as IH_{0,0}˜IH_{783,0}. Similarly, the neuron connection weights between the 784 input neurons I₀˜I₇₈₃ of the input layer 110 and the neurons H₀-H₃₀ of the hidden layer 120 are indicated as IH_{0,0}˜IH_{783,0} and (IH_{0,1}˜IH_{783,1})˜(IH_{0,29}˜IH_{783,29}) Consequently, there are 734×30 neuron connection weights between the input layer 110 and the hidden layer 120.

The 30 neurons H₀˜H₂₉ of the hidden layer 120 are connected with the ten output neurons O₀˜O₉ of the output layer 130. Consequently, 30×10 neuron connection weights between the neurons H₀-H₂₉ of the hidden layer 120 and the output neuron O₀˜O₉ of the output layer 130 are indicated as (HO_{0,0-1}˜HO_{29,0})˜(HO_{0,9}˜HO_{29,9}). Moreover, the neuron connection weights (IH_{0,0}˜IH_{783,0})˜(IH_{0,29}˜IH_{783,29}) and (HO_{0,0}˜HO_{29,0})˜(HO_{0,9}˜HO_{29,9}) are collaboratively combined as a weight group.

The neuron of each layer is calculated according to the neurons of the previous layer and the corresponding neuron connection weights. Take the neuron H₀ of the hidden layer 120 for example. The neuron H₀ of the hidden layer 120 is calculated by the following formula:

$${H}_{0} = {I}_{0} \times {IH}_{0 , 0} + {I}_{1} \times {IH}_{1 , 0} + … + {I}_{783} \times {IH}_{783 , 0} = {\sum }_{i = 0}^{783} {I}_{i} \times {IH}_{i , 0}$$

Or some function on

$${\sum }_{i = 0}^{783} {I}_{i} \times {IH}_{i , 0} .$$

### That is,

$${H}_{0} = f ( {\sum }_{i = 0}^{783} {I}_{i} \times {IH}_{i , 0} )$$

The other neurons H₁˜H₂₉ of the hidden layer 120 are calculated by the similar formula.

Similarly, the output neuron O₀ of the output layer 130 is calculated by the following formula:

$${O}_{0} = {\sum }_{j = 0}^{29} {H}_{j} \times {HO}_{j , 0} or {O}_{0} = f ( {\sum }_{j = 0}^{29} {H}_{j} \times {HO}_{j , 0} )$$

The other neurons O₀˜O₀ of the output layer 130 are calculated by the similar formula.

Before the practical applications of the neural network system 100, the neural network system 100 has to be in a training phase to acquire the values of all neuron connection weights in the weight group. After the values of all neuron connection weights in the weight group are acquired through many iterations of training, the well-trained neural network system 100 is established.

In an application phase, the single digital number written on the handwriting board 102 can be recognized by the neural network system 100. As shown in FIG. 1, the number “7” is written on the handwriting board 102. Since the neuron O₇ of the output layer 130 has the highest value, the number “7” is recognized by the neural network system 100.

The example of the neural network system 100 as shown in FIG. 1 is presented herein for purpose of illustration and description only. In case that the neural network system is more complicated, the neural network system comprises plural hidden layer to increase the recognition capability. Moreover, the sizes of the hidden layers are not restricted.

In another embodiment, the neuron of each layer is calculated according to the neurons of the previous layer, the corresponding neuron connection weights and a bias value. Take the neuron H₀ of the hidden layer 120 as an example, the neuron H₀ of the hidden layer 120 is calculated by the following formula;

$${H}_{0} = {BIH}_{0} + {I}_{0} \times {IH}_{0 , 0} + {I}_{1} \times {IH}_{1 , 0} + … + {I}_{783} \times {IH}_{783 , 0} = {BIH}_{0} + {\sum }_{i = 0}^{783} {I}_{i} \times {IH}_{i , 0} Or$$

$${H}_{0} = f ( {BIH}_{0} + {\sum }_{i = 0}^{783} {I}_{i} \times {IH}_{i , 0} )$$

In the above formula, BIH₀ is the bias value. That is, the weight group of the neural network system comprises plural neuron connection weights and the plural bias values. After the training phase, all neuron connection weights and all bias values in the weight group are acquired.

Generally, the bias value BIH₀ may be considered as a neuron connection weight. That is, the term “BIH₀” is a product of a virtual neuron and the bias value BIH₀. However, the virtual neuron is always 1.

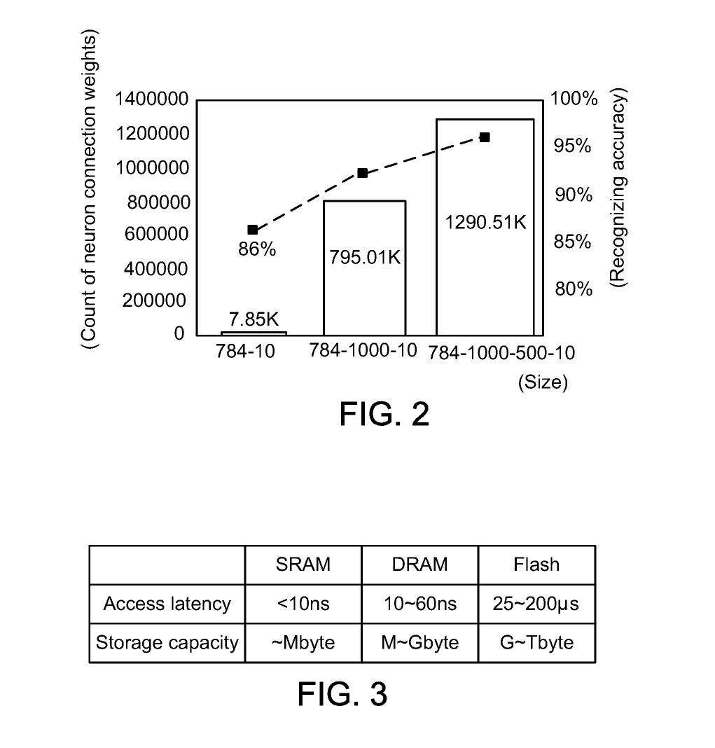

FIG. 2 is a plot illustrating the recognizing accuracy and the count of neuron connection weights for the neural network systems with different sizes.

In case that the neural network system comprises the input layer and the output layer only (e.g., the size is 784-10), the count of neuron connection weights is about 7.85K (the bias values are included in the neuron connection weights) and the recognizing accuracy is about 86%.

As the complexity of the neural network system is increased and the neural network system comprises an input layer, a hidden layer and an output layer (e.g., the size is 784-1000-10), the count of neuron connection weights is about 795.01 K and the recognizing accuracy is increased to about 92%. As the complexity of the neural network system is further increased and the neural network system comprises an input layer, two hidden layer and an output layer (e.g., the size is 784-1000-500-10), the count of neuron connection weights is about 1290.51K and the recognizing accuracy is increased to about 96%.

That is, as the complexity of the neural network system is increased, the recognizing accuracy is increased and the count of neuron connection weights in the weight group is increased. Although the increase of the complexity of the neural network system increases the recognizing accuracy, the problems of storing and reading the neuron connection weights occur.

For example, a well-known AlexNet image recognition system comprises four layers and the size is 43264-4096-4096-1000. If one neuron connection weight is indicated by a 16-bit floating point number, the memory space for storing all neuron connection weights is about 396 Mbytes.

FIG. 3 schematically illustrates the access latency and the storage capacity of various storage devices. For choosing a suitable storage device for the neural network system, the access latency and the storage capacity of the storage device should be taken into consideration. As shown in FIG. 3, the SRAM has the shortest access latency (<10 ns) and the fastest access speed. However, as the amount of stored data increases, the power consumption of the SRAM gradually increases. The flash memory has the largest memory capacity to store data. Since the flash memory has the longest access latency (about 25˜200 μs) and the slowest access speed, the flash memory is not suitably applied to the neural network system that requires high performance computation.

Generally, the DRAM is suitably used as the storage device of the neural network system to store the neuron connection weights. Moreover, the neural network system comprises a processing unit for accessing the neuron connection weights and performing associated computations.

In the application phase, the factors influencing the computational latency include the data access time of the external storage device and the computing time of the processing unit itself. Since the data access time of the DRAM is much longer than the computing time of the processing unit, the overall performance of the neural network system is highly dependent on the data access time of the external storage device.

The present invention provides a method of designing a neural network system. For example, the neural network system is used for recognizing digital numbers.

In an embodiment, the neural network system for recognizing digital numbers comprises an input layer, two hidden layers and an output layer. The size of the neural network system is 784-1000-500-10. If the weight group contains the above-mentioned bias values, the weight group contains 1290.51K (=1290.51×10³) neuron connection weights. After the training phase of the neural network system, the values of all neuron connection weights in the weight group are acquired. If one neuron connection weight is indicated by a 16-bit floating point number, the memory space for storing all neuron connection weights is about 25.81 Mbytes.

In the application phase, the well-trained neural network system 100 performs computations according to the neuron connection weights in the weight group. When the number written on the handwriting board 102 is recognized by the neural network system 100, the recognizing accuracy is about 96.25%.

Since the external storage device stores so many neuron connection weights, the access speed influences the computing performance of the processing unit. When the technology of the present invention is applied to the neural network system with the same size, the amount of the stored data is reduced and the recognizing accuracy of the neural network system is still satisfied. The technology of the present invention will be described as follows.

As mentioned above, the weight group of the neural network system contains 1290.51 K neuron connection weights. After the training phase, it is found that most of the neuron connection weights are nearly zero. In accordance with the present invention, the values of the neuron connection weights in the weight group are modified according to a threshold value Wₜₕ.

For example, if the absolute value of the neuron connection weight is lower than the threshold value Wₜₕ, the value of the neuron connection weight is modified to be zero. The value of the neuron connection weight Wi′ may be expressed as the following formula:

$${W}_{i}^{′} = \{ \begin{matrix}0 , & if \vert {W}_{i} \vert < {W}_{th} \\ {W}_{i} , & otherwise\end{matrix} .$$

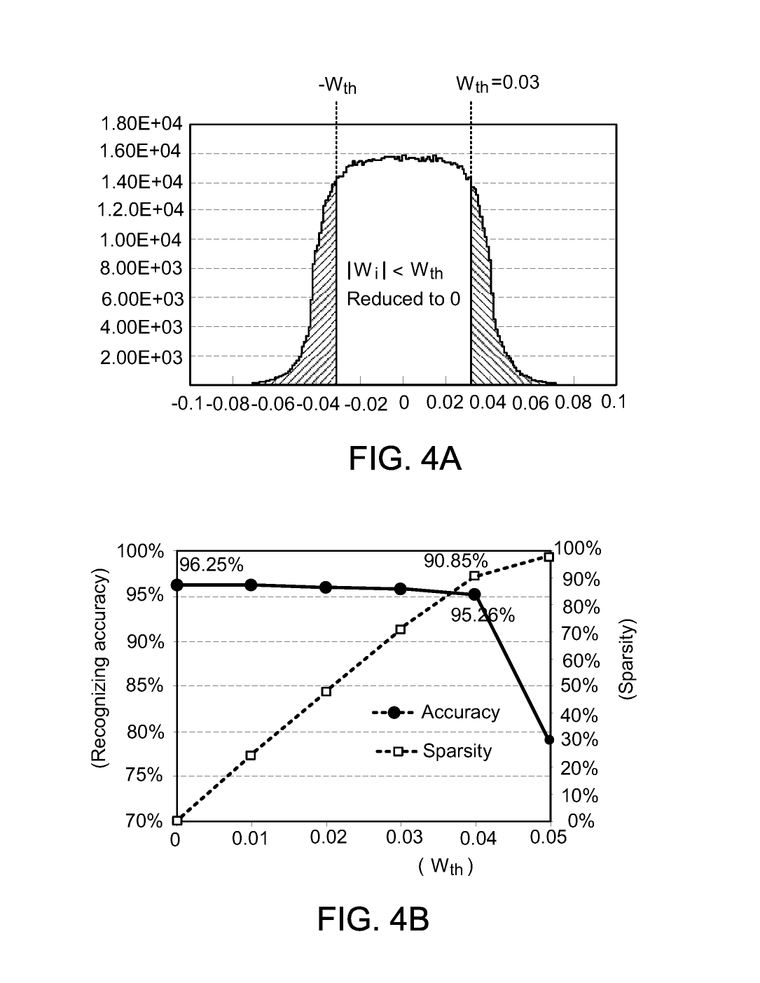

FIG. 4A schematically illustrates the distribution curves of the neuron connection weights of the neural network system. After the training phase, the plot of FIG. 4A shows that most of the neuron connection weights are nearly zero. For example, the threshold value Wₜₕ is 0.03. If the absolute value of the neuron connection weight is lower than the threshold value Wₜₕ, the value of the neuron connection weight is modified to be zero.

FIG. 4B is a plot illustrating the recognizing accuracy and the sparsity for different threshold values Wₜₕ.

If the threshold value Wₜₕ is 0, the values of all neuron connection weights are not modified. Under this circumstance, the sparsity of the neuron connection weights is about 0% and the recognizing accuracy is about 96.25%.

As the threshold value Wₜₕ is gradually increased, the count of the neuron connection weights to be modified is gradually increased. Under this circumstance, the recognizing accuracy of the neural network system has a tendency toward decline.

In case that the threshold value Wₜₕ is 0.04, the sparsity is 90.85%. That is, about 90.85% of the neuron connection weights are zero. Meanwhile, the recognizing accuracy of the neural network system is about 95.26%.

In case that the threshold value Wₜₕ is 0.05, about 98.5% of the neuron connection weights are zero. Meanwhile, the recognizing accuracy of the neural network system is largely decreased to 78%.

As mentioned above, if some values of the neuron connection weights in the weight group are properly modified, the data storage amount of the external storage device is largely reduced and the recognizing accuracy is still acceptable.

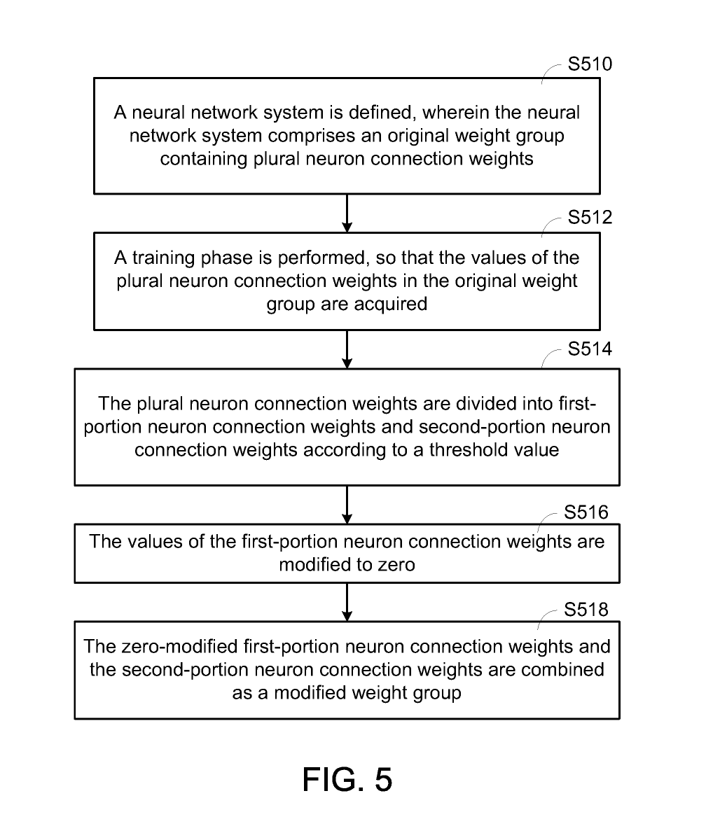

FIG. 5 is a flowchart illustrating a method of designing a neural network system according to an embodiment of the present invention.

Firstly, a neural network system is defined (Step S510). The neural network system comprises an original weight group containing plural neuron connection weights. For example, if the size of the neural network system is X-Y-Z, the count of the neuron connection weights in the weight group is at least (XY+YZ).

Then, a training phase is performed, so that the values of the plural neuron connection weights in the original weight group are acquired (Step S512).

Then, the neuron connection weights are divided into first-portion neuron connection weights and second-portion neuron connection weights according to a threshold value Wₜₕ (Step S514). Then, the values of the first-portion neuron connection weights are modified to zero (Step S516).

Then, the zero-modified first-portion neuron connection weights and the second-portion neuron connection weights are combined as a modified weight group (Step S518).

After the modified weight group is generated, the neural network system is in an application phase. In the application phase, the neural network system performs the computations according to the modified weight group.

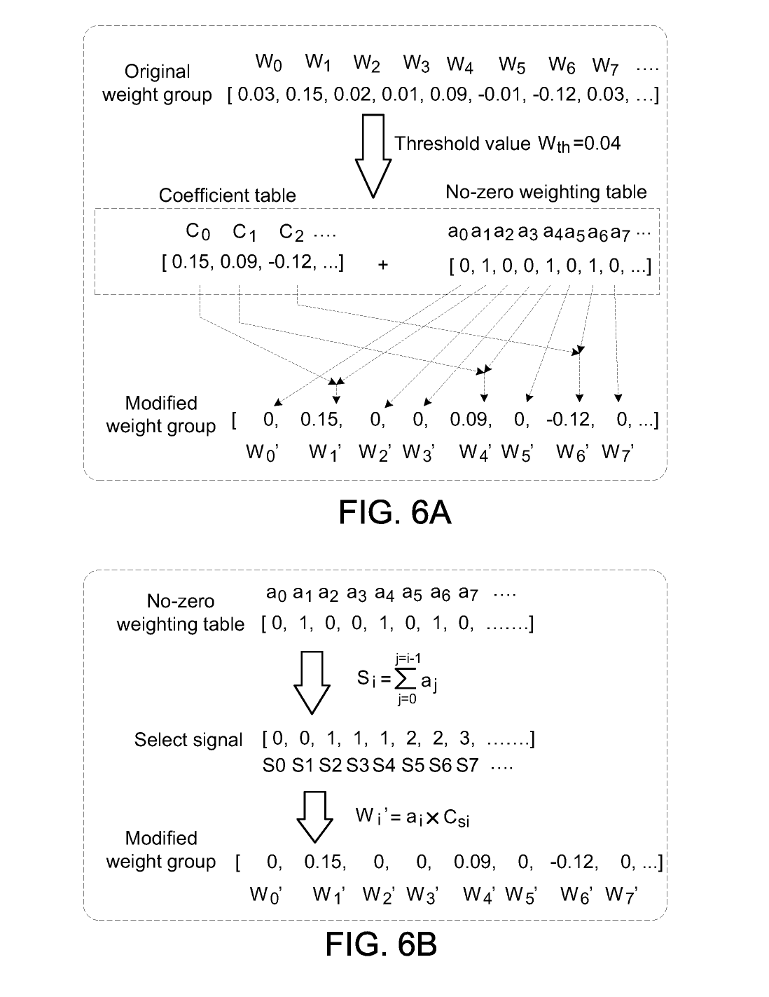

FIG. 6A schematically illustrates the storage format and the mapping rule of the neuron connection weights for the neural network system of the present invention. After the training phase, an original weight group is acquired. The original weight group contains eight neuron connection weights W₀˜W₇. The values of the neuron connection weights W₀˜W₇ are 0.03, 0.15, 0.02, 0.01, 0.09, −0.01, −0.12 and 0.03, respectively. It is noted that the count of the neuron connection weights in the original weight group is not restricted. That is, the count of the neuron connection weights in the original weight group may be varied according to the practical requirements.

In an embodiment, the storage device comprises a coefficient table and a non-zero weighting table.

Then, a comparing process is performed. That is, the absolute values of all neuron connection weights are compared with the threshold value (e.g., Wₜₕ=0.04). If the absolute value of a specified neuron connection weight is higher than or equal to the threshold value, the specified neuron connection weight is stored in a coefficient table. In addition, an indicating bit “1” is stored in a non-zero weighting table to indicate that the value of the specified neuron connection weight is not zero. If the absolute value of a specified neuron connection weight is lower than the threshold value, the specified neuron connection weight is not stored in the coefficient table. In addition, an indicating bit “0” is stored in a non-zero weighting table to indicate that the value of the specified neuron connection weight is zero.

After the comparing process, only the absolute values higher than or equal to the threshold value are stored in the coefficient table. For example, C₀=0.15, C₁=0.09, C₂=−0.12, . . . , and so on. The indicating bits a₀˜a₇ in the non-zero weighting table are respectively related to the neuron connection weights W_{0′}˜W_{7′} of the modified weight group. In case that the non-zero weighting table contains indicating bits “1” in the position index P, that means the correspondent connection weight is non-zero, and it's absolute value is higher than or equal to the threshold value. The connection weight of the position index P is stored in the coefficient table. As shown in FIG. 6A, the seven indicating bits a₀˜a₇ in the non-zero weighting table are “0”, “1”, “0”, “0”, “1”, “0”, “1” and “0”, respectively. In other words, three absolute values in the coefficient table are higher than or equal to the threshold value. They are W₁, W₄, W₆.

After the above data are stored in the storage device, the total bit number of the storage space is expressed by the following formula:

D_{storage}=b×(1−Sₚ)×N_{weight}+N_{weight}

In the above formula, b is the bit number corresponding to each neuron connection weight (e.g., 16 bits), Sₚ is the sparsity, and N_{weight} is the total count of the neuron connection weights.

For example, in case that the weight group of the neural network system contains 1290.51K neuron connection weights and the threshold value Wₜₕ is 0.04, the total bit number of the storage space is equal to [(16)×(1−90.85%)×1290510+1290510]. The total bit number is equivalent to about 1.53 Mbytes. As mentioned above, the storage space for the original weight group is about 25.81 Mbytes. Since the required storage space of the neural network system of the present invention is largely reduced, the time period of accessing data between the processing unit and the external storage space is effectively reduced.

Moreover, the modified weight group can be recovered from the coefficient table and the non-zero weighting table. The indicating bits of the non-zero weighting table are respectively related to the neuron connection weights of the modified weight group. Consequently, in case that the indicating bit in the non-zero weighting table is “0”, the corresponding neuron connection weight in the modified weight group is 0. Whereas, all the non-zero connection weights in the modified weight group can be found sequentially in the coefficient table corresponding to the indicating bit “1” stored in the non-zero weighting table.

Please refer to FIG. 6A. The indicating bit a₀ in the non-zero weighting table is “0”. That is, the value of the neuron connection weight W_{0′} in the modified weight group is 0. The indicating bit a₁ in the non-zero weighting table is “1”. That is, the value of the neuron connection weight W_{1′} in the modified weight group is equal to the coefficient C₀ of the coefficient table (i.e., W_{1′}=0.15). The indicating bit a₂ in the non-zero weighting table is “0”. That is, the value of the neuron connection weight W_{2′} in the modified weight group is 0. The indicating bit a₃ in the non-zero weighting table is “0”. That is, the value of the neuron connection weight W_{3′} in the modified weight group is 0. The indicating bit a₄ in the non-zero weighting table is “1”. That is, the value of the neuron connection weight W_{4′} in the modified weight group is equal to the coefficient C₁ of the coefficient table (i.e., W_{4′}=0.09). The indicating bit a₅ in the non-zero weighting table is “0”. That is, the value of the neuron connection weight W_{5′} in the modified weight group is 0. The indicating bit a₆ in the non-zero weighting table is “1”. That is, the value of the neuron connection weight W_{6′} in the modified weight group is equal to the coefficient O₂ of the coefficient table (i.e., W₆=−0.12). The indicating bit a₇ in the non-zero weighting table is “0”. That is, the value of the neuron connection weight W₇ in the modified weight group is 0. The rest may be deduced by analogy. Consequently, the modified weight group is acquired and applied to the neural network system.

FIG. 6B schematically illustrates a process of creating the modified weight group for the neural network system of the present invention.

Firstly, an accumulation value Si is defined, wherein S₀=0. The accumulation value Si is expressed by the following formula:

$$Si = {\sum }_{j = 0}^{j = i - 1} {a}_{j}$$

As mentioned above, S₀=0. Consequently, S₁=a₀=0, S₂=a₀+a₁=1, S₃=a₀+a₁+a₂=1, S₄=a₀+a₁+a₂+a₃=1, S₆=a₀+a₁+a₂+a₃+a₄=2, S₆=a₀+a₁+a₂+a₃+a₄+a₆=2, and S₇=a₀+a₁+a₂+a₃+a₄+a₆+a₆=3. The rest may be deduced by analogy.

Moreover, the neuron connection weights of the modified weight group are obtained according to the indicating bits of the non-zero weighting table, the accumulation values and the coefficients of the coefficient table. That is, the neuron connection weight W′=a₁×C_{Si}. That is, the neuron connection weights W_{0′}˜W_{7′} are obtained by the following formulae: W₀′=a₀×Cₛ₀=a₀×C₀=0×0.15=0, W_{1′}=a₁×Cₛ₁=a₁×C₀=1×0.15=0.15, W_{2′}=a₂×Cₛ₂=a₂×C₁=0×0.09=0, W_{3′}=a₃×Cₛ₃=a₃×C₁=0×0.09=0, W_{4′}=a₄×Cₛ₄=a₄×C₁=1×0.09=0.09, W_{5′}=a₅×Cₛ₅=a₅×C₂=0×−0.12=0, W_{6′}=a₆×Cₛ₆=a₆×C₂=1×−0.12=−0.12, and W_{7′}=a₇×Cₛ₇=a₇×C₃=0×C₃=0.

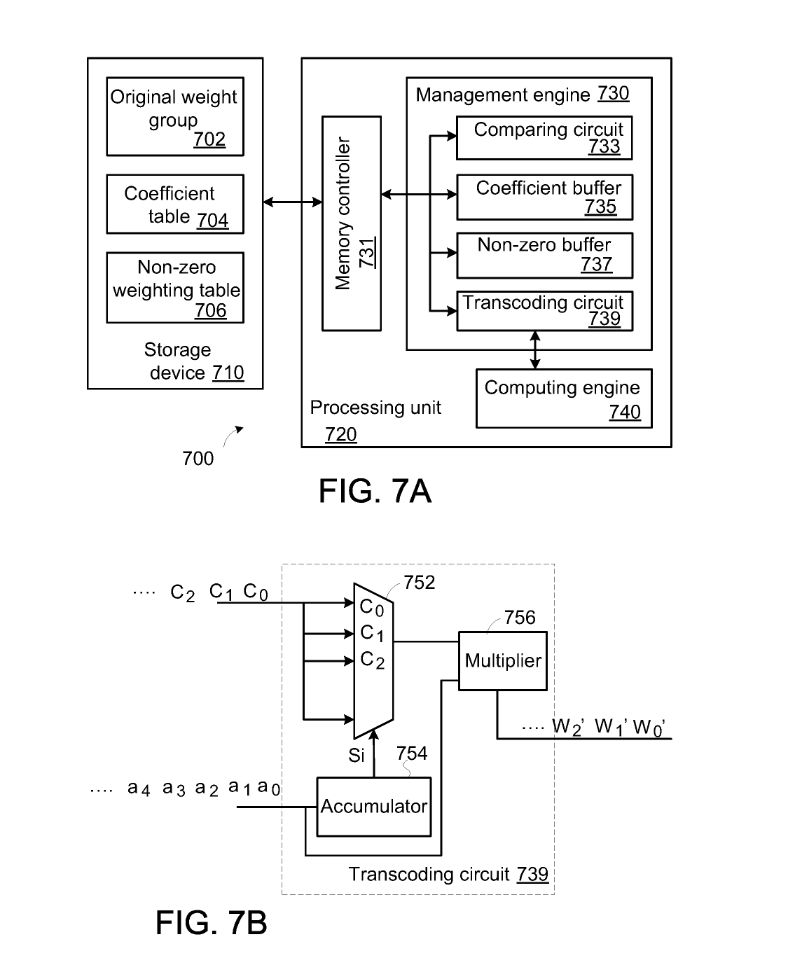

FIG. 7A is a schematic functional block diagram illustrating the hardware architecture of a neural network system according to an embodiment of the present invention. As shown in FIG. 7A, the hardware architecture 700 of the neural network system comprises a storage device 710 and a processing unit 720. For example, the storage device 710 is a DRAM such as a DDR3 DRAM. Moreover, an original weight group 702, a coefficient table 704 and a non-zero weighting table 706 are stored in the storage device 710.

The processing unit 720 comprises a memory controller 731, a management engine 730 and a computing engine 740. The management engine 730 is used for converting the original weight group 702 into the coefficient table 704 and the non-zero weighting table 706. The management engine 730 creates the modified weight group according to the coefficient table 704 and the non-zero weighting table 706 and transmits the modified weight group to the computing engine 740. The computing engine 740 performs associated computations according to the modified weight group.

The management engine 730 comprises a comparing circuit 733, a coefficient buffer 735, a non-zero buffer 737 and a transcoding circuit 739.

The memory controller 731 is connected with the storage device 710. The memory controller 731 can access the data of the storage device 710. In the comparing process, the memory controller 731 reads the original weight group 702 from the storage device 710 and transmits all neuron connection weights W₀˜W₇ to the comparing circuit 733 sequentially.

The absolute values of all neuron connection weights W₀˜W₇ are compared with the threshold value (e.g., Wₜₕ=0.04) by the comparing circuit 733. If the absolute value of the neuron connection weight is higher than or equal to the threshold value, the neuron connection weight is stored into the coefficient buffer 735 and an indicating bit “1” is generated and stored into the non-zero buffer 737. Whereas, if the absolute value of the neuron connection weight is lower than the threshold value, the neuron connection weight is not stored into the coefficient buffer 735 and an indicating bit “0” is generated and stored into the non-zero buffer 737.

The data in the coefficient buffer 735 may be written into the coefficient table 704 of the storage device 710 by the memory controller 731. Similarly, the indicating bits in the non-zero buffer 737 may be written into the non-zero weighting table 706 by the memory controller 731.

After all neuron connection weights of the original weight group 702 are inputted into the comparing circuit 733, the coefficient table 704 and the non-zero weighting table 706 are created.

FIG. 7B is a schematic circuit block diagram illustrating the transcoding circuit used in the hardware architecture of the neural network system as shown in FIG. 7A. As shown in FIG. 7B, the transcoding circuit 739 comprises a multiplexer 752, an accumulator 754 and a multiplier 756.

In the application phase, the computing engine 740 has to modify the weight group. The memory controller 731 reads the coefficient table 704 and the non-zero weighting table 706 from the storage device 710. In addition, the coefficient C₀˜C₇ in the coefficient table 704 and the indicating bits a₀˜a₇ in the non-zero weighting table 706 are inputted into the transcoding circuit 739 by the memory controller 731.

The coefficient C₀˜C₇ of the coefficient table 704 are inputted into the input terminals of the multiplexer 752. The indicating bits a₀˜a₇ are accumulated by the accumulator 754. The accumulation value Si is outputted from the accumulator 754 to a select terminal of the multiplexer 752. A first input terminal of the multiplier 756 is connected with the output terminal of the multiplexer 752. A second input terminal of the multiplier 756 receives the indicating bits a₀˜a₇. The neuron connection weights W_{0′}˜W_{7′} of the modified weight group are sequentially outputted from the output terminal of the multiplier 756. In an embodiment, the neuron connection weights W_{0′}˜W_{7′} of the modified weight group by the transcoding circuit 739 according to the formula: W′=ai×C_{Si}.

It is noted that the hardware circuits used in the neural network system of the present invention are not restricted to the circuits shown in FIGS. 7A and 7B. For example, other circuits or software programs may be employed to convert the original weight group into the modified weight group and perform the associated computations. For example, a portion or the entire of the hardware circuit function of the neural network system as shown in FIG. 7A may be implemented through a handheld device or a computer host.

For example, the neural network system is implemented through a cloud computer host. After a training phase, the values of the neuron connection weights in the modified weight group are acquired. Then, the coefficient table 704 and the non-zero weighting table 706 are created by a software program or another circuit. Under this circumstance, the cloud computer host implements a greater portion of the function of the management engine 730 in the processing unit 720. In case that a handheld device or an Internet of things device (i.e., an IoT device) acquires the coefficient table and the non-zero weighting table through network connection or other methods, the functions of the computing engine 740 and the transcoding circuit 739 can be achieved.

From the above descriptions, the present invention provides a method of designing a neural network system. Firstly, a coefficient table and a non-zero weighting table are generated according to the result of comparing the neuron connection weights of an original weight group with a threshold value. In an application phase, a modified weight group is generated according to the coefficient table and the non-zero weighting table and applied to the neural network system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of designing a neural network system, the method comprising steps of:
defining the neural network system, wherein the neural network system comprises an original weight group containing plural neuron connection weights;
performing a training phase to acquire values of the plural neuron connection weights in the original weight group;
dividing the plural neuron connection weights into first-portion neuron connection weights and second-portion neuron connection weights according to a threshold value, wherein absolute values of the first-portion neuron connection weights are lower than the threshold value;
allowing the values of the first-portion neuron connection weights to be modified to zero; and
generating a modified weight group, wherein the zero-modified first-portion neuron connection weights and the second-portion neuron connection weights are combined as the modified weight group.

2. The method as claimed in claim 1, further comprising a step of performing an application phase, wherein in the application phase, the neural network system performs computations according to the modified weight group.

3. The method as claimed in claim 2, further comprising a step of generating a coefficient table and a non-zero weighting table according to the first-portion neuron connection weights and the second-portion neuron connection weights.

4. The method as claimed in claim 3, further comprising a step of generating the modified weight group according to the coefficient table and the non-zero weighting table.

5. The method as claimed in claim 3, wherein if an absolute value of a first neuron connection weight in the original weight group is higher than or equal to the threshold value, the value of the first neuron connection weight is stored in the coefficient table and a first indicating bit is stored in the non-zero weighting table to indicate that the value of the first neuron connection weight is not zero.

6. The method as claimed in claim 5, wherein the first neuron connection weight is assigned to the second-portion neuron connection weights.

7. The method as claimed in claim 5, wherein if an absolute value of a second neuron connection weight in the original weight group is lower than the threshold value, the value of the second neuron connection weight is not stored in the coefficient table and a second indicating bit is stored in the non-zero weighting table to indicate that the value of the second neuron connection weight is modified to zero.

8. The method as claimed in claim 7, wherein the second neuron connection weight is assigned to the first-portion neuron connection weights.

9. The method as claimed in claim 3, wherein the neural network system further comprises a storage device and a processing unit, and the coefficient table and the non-zero weighting table are stored in the storage device.

10. The method as claimed in claim 9, wherein the processing unit comprises a management engine for converting the coefficient table and the non-zero weighting table into the modified weight group.

11. The method as claimed in claim 10, wherein the management engine is a cloud management engine.

12. The method as claimed in claim 10, wherein the processing unit further comprises a computing engine, wherein the computing engine receives the modified weight group from the management engine and performs the computations according to the modified weight group.

13. The method as claimed in claim 12, wherein the processing unit is a handheld device or an Internet of things device.
